(19) United States
(12) Patent Application Publication
(10) Pub. No.: US 2023/0360113 A1
(43) Pub. Date: Nov. 9, 2023

(54) SHIPPING OPTION RECOMMENDATION AND MANAGEMENT

(71) Applicant: eBay Inc., San Jose, CA (US)

(72) Inventors: Abhishek Kansal, San Jose, CA (US); Magdalena Donnels, San Jose, CA (US); Alex Muthukumar Joseph, San Jose, CA (US); Zachary Graham, San Jose, CA (US)

(21) Appl. No.: 17/736,187

(22) Filed: May 4, 2022

(51) Int. Cl. G06Q 30/06

(52) U.S. Cl. CPC G06Q 30/0641

(57) ABSTRACT

Various examples include systems, methods, and non-transitory computer-readable media for generating shipping option recommendations for listing items. Consistent with these examples, a method includes receiving a request to list a first item. The method further includes determining a characteristic of the first item based on item data. The method further includes identifying a set of transactions corresponding to a number of shipped items that share the characteristic with the first item. The method further includes generating a filtered set of transactions from the set of transactions based on the location data. The method further includes identifying a first shipping option based on the filtered set of transactions and generating a shipping option recommendation based on the identified first shipping option.

### TECHNICAL FIELD

The subject matter disclosed herein generally relates to methods, systems, and machine-readable storage media for data processing, and more particularly, but not by way of limitation, to generate shipping option recommendations for items.

### BACKGROUND

Conventionally, online platforms publish digital content, such as a listing of an item that includes shipping information and a description of one or more characteristics of the listed item. Some conventional online platforms require user input of shipping information in greater detail. A large amount of information input can burden the users (e.g., increased cognitive load) and cause system latency and unnecessary consumption of computing resources.

### BRIEF DESCRIPTION OF THE SEVERAL VIEWS OF THE DRAWINGS

In the drawings, which are not necessarily drawn to scale, like numerals may describe similar components in different views. Like numerals having different letter suffixes may represent different instances of similar components. Some examples are illustrated by way of example, and not limitation, in the figures of the accompanying drawings in which:

FIG. 1 depicts a block diagram showing an example networked environment in which the disclosed technology may be practiced, according to various examples.

FIG. 2 depicts a block diagram illustrating a shipping option management system for generating shipping option recommendations for items, according to various examples.

FIG. 3 depicts a flowchart illustrating an example method for generating shipping option recommendations for items by an example shipping option management system during operation, according to various examples.

FIG. 4 depicts a flowchart illustrating another example method for generating shipping option recommendations for items by an example shipping option management system during operation, according to various examples.

FIG. 5 depicts a block diagram illustrating an example user interface caused to be displayed by an example shipping option management system during operation, according to various examples.

FIG. 6 depicts a block diagram illustrating an example user interface caused to be displayed by an example shipping option management system during operation, according to various examples.

FIG. 7 depicts a block diagram illustrating an architecture of software, according to some examples.

FIG. 8 illustrates a diagrammatic representation of a machine in the form of a computer system within which a set of instructions may be executed for causing a machine to perform any one or more of the methodologies discussed herein, according to some examples.

### DETAILED DESCRIPTION

The description that follows includes systems, methods, techniques, instruction sequences, and computing machine program products that embody illustrative examples of the present disclosure. In the following description, for purposes of explanation, numerous specific details are set forth in order to provide a thorough understanding of examples. It will be evident, however, to one skilled in the art that the present inventive subject matter may be practiced without these specific details.

Reference in the specification to “one example” or “an example” means that a particular feature, structure, or characteristic described in connection with the example is included in at least one example of the present subject matter. Thus, the appearances of the phrase “in one example” or “in an example” appearing in various places throughout the specification are not necessarily all referring to the same example.

For purposes of explanation, specific configurations and details are set forth in order to provide a thorough understanding of the present subject matter. However, it will be apparent to one of ordinary skill in the art that examples of the subject matter described may be practiced without the specific details presented herein, or in various combinations, as described herein. Furthermore, well-known features may be omitted or simplified in order not to obscure the described examples. Various examples may be given throughout this description. These are merely descriptions of specific examples. The scope or meaning of the claims is not limited to the examples given.

Various examples include systems, methods, and non-transitory computer-readable media for generating shipping option recommendations for listing items. Specifically, a shipping option management system provides shipping option analysis based on user behaviors and generates shipping option recommendations for sellers when listing an item for sale. The shipping option management system identifies shipping options that drive maximum conversion rate while minimizing sellers’ costs and shipping risks (e.g., fraud or returns).

In various examples, the shipping option management system uses data mining and other relevant techniques to leverage user data, including user behavioral data and transaction data, and generate default shipping option recommendations that users likely choose (e.g., sellers) when listing the same or similar items. As a result, a seller can make minimal clicks or choices when entering shipping information during a product listing process before receiving shipping option recommendations for items.

In various examples, the shipping option management system receives a request to list an item (e.g., the first item) for sale in an online marketplace. The request is associated with item data. Item data may include location data of the item and product information describing one or more characteristics of the item. Characteristics of an item, such as a jacket, may include color, clothing type (e.g., jacket), level of formalness (formal, business casual, casual, sportswear, etc.), style type (trendy, preppy, funky, punk, street, classy, avant-garde, sporty, etc.), and the like. In various examples, certain characteristics of an item, such as price and brand, may correlate to higher service expectations from buyers. For example, a customer buying a set of high-end golf clubs may likely prefer faster shipping and be willing to pay extra for that shipping service. In such a scenario, an expedited shipping option may be recommended over an economy shipping option. In another example, clothing type, formal wear may require more protective packaging to minimize the risk of damage during transit. The protective packaging (e.g., packing paper, packaging foam, padded divider sets) may only be available with specific shipping options (e.g., standard shipping). Other characteristics of an item may include item fragility, item perishability, hazardous and/or flammable item (e.g., lithium batteries, battery-powered devices, or alcoholic beverages), etc.

In various examples, location data of an item may include the delivery location (e.g., location of a marketplace 516) and the location of the item (e.g., shipping location). In various examples, item data includes a product category of the item, a quantity of the item, and/or the size of a package that fits the item for listing.

In various examples, the shipping option management system determines one or more characteristics of an item based on the item data. Characteristics of an item may be assigned with weight values based on one or more priority rules. For example, the clothing type may be assigned a larger weight value than the level of formalness, which is assigned a larger weight value than the clothing color.

In various examples, the shipping option management system identifies a user account associated with a reputation rating above a threshold rating, such as a 4.5 out of 5 rating. By identifying user accounts with higher ratings, the shipping option management system likely identifies more sophisticated and successful sellers that are able to provide a higher degree of buyer satisfaction. In various examples, one or more user accounts may be identified. In various examples, the reputation rating is determined partially based on an account status being “active” over a pre-determined period of time (e.g., 12 months for most product categories, less than 12 months for newer product categories).

In various examples, once the user account is identified, the shipping option management system identifies a set of transactions associated with a number of shipped items that share one or more characteristics with the item for listing. In various examples, the shipping option management system pulls transaction data based on listings associated with the identified user accounts.

In various examples, the shipping option management system generates a filtered set of transactions based on the location data that includes the delivery location and the current location of the item for listing. The set of transactions may be filtered based on the item’s shipping and delivery locations. In various examples, the shipping option management system may update the filtered set of transactions by excluding one or more transactions based on occurrences of events associated with the one or more transactions. An event may be an instance of reported late delivery, or an instance of a negative review submitted by a buyer.

In various examples, the shipping option management system identifies one or more shipping options for shipping the item based on the filtered set of transactions. More specifically, the shipping option for shipping the item is identified from shipping options previously selected for shipping items in the filtered set of transactions that share the characteristic with the item. The identified shipping options are associated with a selection probability (e.g., over 50%) higher than the selection probabilities of other shipping options selected by the user account. For example, a flat rate shipping option for shipping a particular item within a given geographical region (e.g., the US) may be more frequently selected by the seller associated with the user account than an expedited shipping option. For example, a selection probability of a flat rate shipping option is 70%, whereas a selection probability of an expedited shipping option for shipping the same or similar item within the geographical region is 30%.

In various examples, the shipping option management system generates a shipping option recommendation for the item based on the identified shipping option (e.g., first shipping option). In various examples, the shipping option management system applies other filtering criteria to narrow the scope of identified transactions for downstream analysis. The filtering criteria include, but are not limited to, shipping volume, the price value of the item for listing relative to the shipping costs, and complaints filed against the identified user account (e.g., identified seller account). In various examples, the shipping option management system prioritizes the identification of user accounts with larger shipping volume, longer shipping history, and higher reputation ratings.

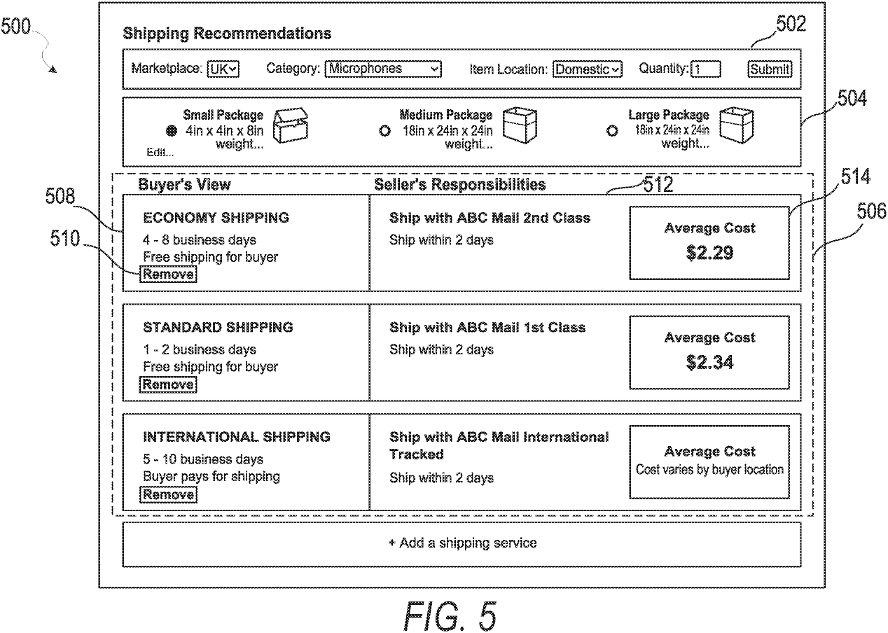

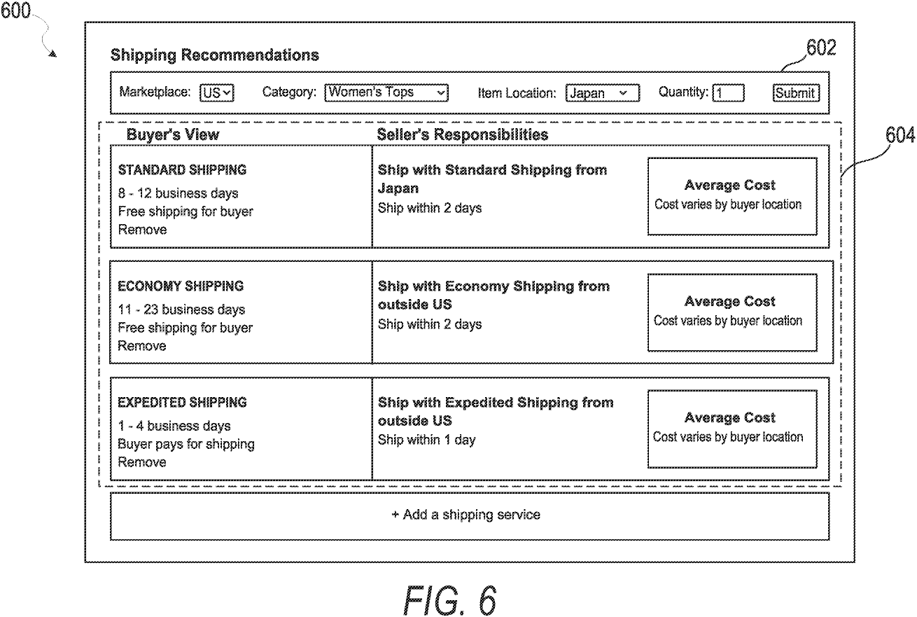

In various examples, the shipping option management system causes the display of the shipping option recommendation on a user interface (e.g., as illustrated in FIG. 5 and FIG. 6) of a client device.

The described techniques provide a number of specific improvements over prior systems. One of such specific improvements results in an improved user interface for electronic devices that display a limited set of information (as illustrated by user interface 500 in FIG. 5 and user interface 600 in FIG. 6). Specifically, the user input display regions 502 and 504, as illustrated in FIG. 5, and user input display region 602, as illustrated in FIG. 6, are simplified to require minimal user input in order to determine shipping options. Additionally, the described techniques provide a particular manner of summarizing and presenting information on electronic devices. For example, the improved user interface collects shipping information (e.g., package weight and dimensions) in a visually intuitive manner. As a further example, the improved user interface presents user interface (UI) interactive elements (instead of generic index or plain texts) to illustrate distinct appearances of shipping boxes, as illustrated in display region 504, representing various dimensions and weight ranges. The described techniques further provide a particular manner of summarizing and presenting information in electronic devices by organizing buyers’ shipping options (e.g., Buyer’s View) and the associated seller’s responsibilities (e.g., Seller’s Responsibilities) in separate columns, as illustrated in display region 506 in FIG. 5. Under this approach, the improved user interface no longer uses conventional user interface methods such as displaying a generic index on a computer.

Under the approach described in various examples herein, the shipping option management system provides functionalities of generating shipping option recommendations based on mining user behavioral data. The user behavioral data includes past transaction history data, such as past transaction history data associated with reputable sellers with larger shipping volumes. The determination is also based on assessing the customer satisfaction rating, the types of shipped items, the price value relative to the shipping costs, whether tracking information is provided, and so on. Under this approach, smaller or inexperienced sellers may benefit from data collected from larger and more sophisticated sellers in the same shipping space. Larger and more sophisticated sellers likely have learned the shipping space and the logistics over time and determined the cost-efficient way to sell the same or similar items. Therefore, their behavioral data serves as a more reliable data source for an accurate determination of improved (e.g., cost-effective) shipping options.

Reference will now be made in detail to examples of the present disclosure, examples of which are illustrated in the appended drawings. The present disclosure may, however, be embodied in many different forms and should not be construed as being limited to the examples set forth herein.

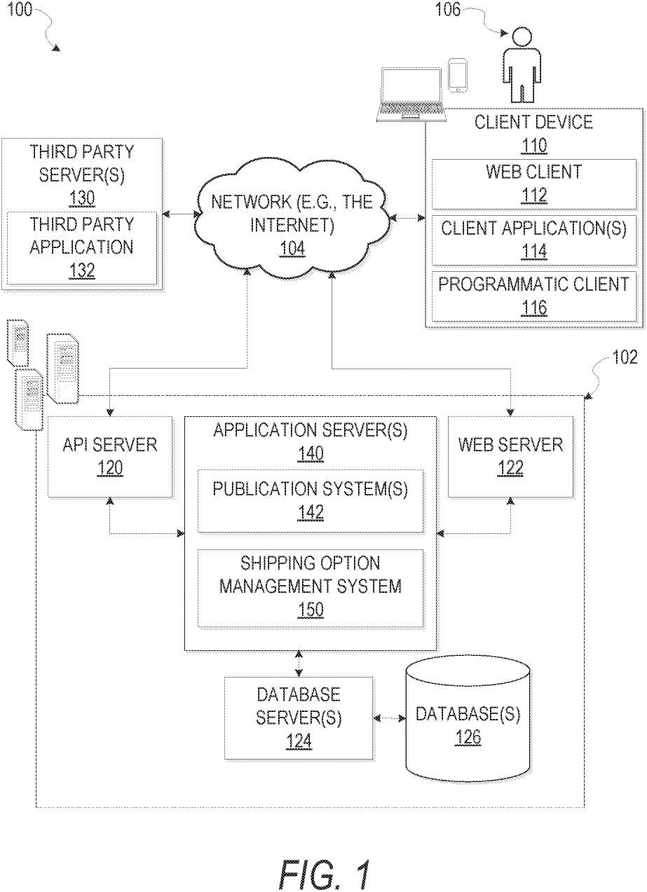

FIG. 1 depicts a block diagram showing an example networked environment 100 in which the disclosed technology may be practiced, according to various examples. With reference to FIG. 1, an example networked environment 100 of a high-level client-server-based network architecture is shown. A networked system 102 provides server-side functionality via a network 104 (e.g., the Internet or wide area network (WAN)) to one or more client devices 110. FIG. 1 illustrates, for example, a web client 112 (e.g., a browser), a client application 114, and a programmatic client 116 executing on client device 110.

The client device 110 may comprise, but is not limited to, mobile phones, desktop computers, laptops, portable digital assistants (PDAs), smart phones, tablets, ultra books, netbooks, multi-processor systems, microprocessor-based or programmable consumer electronics, game consoles, set-top boxes, wearable devices, smart watches, or any other communication devices that a user may utilize to access the networked system 102. In some examples, the client device 110 may comprise a display module to display information (e.g., in the form of user interfaces). In further examples, the client device 110 comprises one or more of touch screens, accelerometers, gyroscopes, cameras, microphones, global positioning system (GPS) devices, and so forth. The client device 110 is a device of a user that can be used to perform a transaction involving digital items within the networked system 102. In some examples, the networked system 102 comprises a network-based marketplace (also referred to as “online marketplace”) that responds to requests for product listings, publishes publications comprising item listings of products or services available on the network-based marketplace, and manages payments for these marketplace transactions. One or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The client device 110 includes one or more applications (also referred to as “apps”) such as, but not limited to, a web browser, messaging application, electronic mail (email) application, an e-commerce site application (also referred to as a marketplace application), and the like. In some examples, if the e-commerce site application is included in the client device 110, then this application is configured to locally provide the user interface and at least some of the functionalities with the application configured to communicate with the networked system 102, on an as-needed basis, for data or processing capabilities not locally available (e.g., to access a database of items available for sale, to authenticate a user, to verify a method of payment, etc.). Conversely, if the e-commerce site application is not included in the client device 110, the client device 110 uses its web browser to access the e-commerce site (or a variant thereof) hosted on the networked system 102.

One or more users 106 may be a person, a machine, or other means of interacting with the client device 110. In various examples, user 106 is not part of the networked environment 100, but may interact with the network architecture 100 via the client device 110 or other means. For instance, user 106 provides input (e.g., touch screen input or alphanumeric input) to the client device 110 and the input is communicated to the networked system 102 via network 104. In this instance, the networked system 102, in response to receiving the input from user 106, communicates information to the client device 110 via network 104 to be presented to user 106. In this way, user 106 can interact with the networked system 102 using the client device 110.

An application program interface (API) server 120 and a web server 122 are coupled to, and provide programmatic and web interfaces respectively to, one or more application servers 140. The application servers 140 may host a publication system 142 and a shipping option management system 150, each of which may comprise one or more components or applications, and each of which may be embodied as hardware, software, firmware, or any combination thereof. A component and a module are used interchangeably, as discussed herein. The application servers 140 are, in turn, shown to be coupled to one or more database servers 124 that facilitate access to one or more information storage repositories or databases 126. In an example, databases 126 are storage devices that store information (e.g., publications, listings, digital content items, product descriptions, images of products, etc.) to be utilized by the shipping option management system 150. Database 126 may also store digital item information (e.g., item data), in accordance with examples.

Additionally, a third-party application 132, executing on one or more third-party servers 130, is shown as having programmatic access to the networked system 102 via the programmatic interface provided by the API server 120. For example, the third-party application 132, utilizing information retrieved from the networked system 102, supports one or more features or functions on a website hosted by the third party. The third-party website, for example, provides one or more promotional, marketplace, or payment functions that are supported by the relevant applications of the networked system 102.

The shipping option management system 150 provides shipping option analysis based on user behaviors and generates shipping option recommendations for sellers when listing an item for sale. In various examples, the shipping option management system 150 uses data mining and other relevant techniques to leverage user data, including user behavioral data and transaction data, and generate shipping option recommendations that drive maximum conversion rate while minimizing sellers’ costs and shipping risks (e.g., fraud or returns). A person of ordinary skill in the art shall appreciate that a conversion rate is a metric that indicates a percentage of online platform visitors that complete an action out of the total number of visitors. Further, a person of ordinary skill in the art shall appreciate that data mining is a process of extracting anomalies, patterns, and correlations in large data sets to predict outcomes.

Further, while the networked environment 100 shown in FIG. 1 employs a client-server architecture, the present inventive subject matter is of course not limited to such an architecture, and could equally well find application in a distributed, or peer-to-peer, architecture system, for example. The shipping option management system 150 can also be implemented as stand-alone software programs, which do not necessarily have networking capabilities.

The web client 112 accesses the shipping option management system 150 via the web interface supported by the web server 122. Similarly, the programmatic client 116 accesses the various services and functions provided by the shipping option management system 150 via the programmatic interface provided by the API server 120. The programmatic client 116 may, for example, be a seller application (e.g., the Turbo Lister application developed by eBay® Inc., of San Jose, California) to enable sellers to author and manage listings on the networked system 102 in an off-line manner, and to perform batch-mode communications between the programmatic client 116 and the networked system 102.

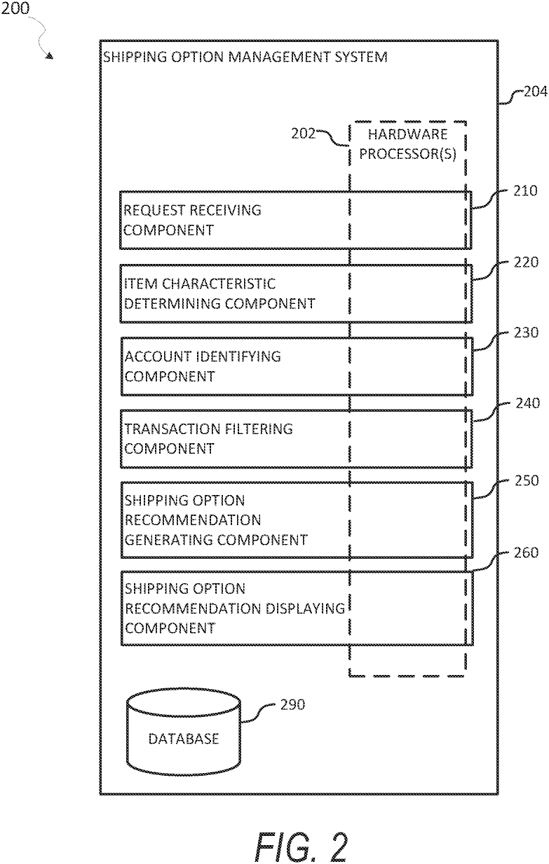

FIG. 2 depicts a block diagram 200 illustrating a shipping option management system 204 for generating shipping option recommendations for items, according to various examples. For some examples, the shipping option management system 204 represents an example of the shipping option management system 150 described with respect to FIG. 1. As shown, the shipping option management system 204 comprises a request receiving component 210, an item characteristic determining component 220, an account identifying component 230, a transaction filtering component 240, a shipping option recommendation generating component 250, a shipping option recommendation displaying component 260, and a database 290.

The request receiving component 210 is configured to receive a request from a client device 110 to list an item (e.g., the first item) for sale in an online marketplace. The request is associated with item data. Item data may include location data of the item and product information describing one or more characteristics of the item. Characteristics of an item, such as a jacket, may include clothing color, clothing type (e.g., jacket), level of formalness (formal, business casual, casual, sportswear, etc.), style type (trendy, preppy, funky, punk, street, classy, avant-garde, sporty, etc.), and the like. Location data of an item may include the location of the marketplace (e.g., delivery location) and the location of the item (e.g., shipping location).

The item characteristic determining component 220 is configured to determine one or more characteristics of an item based on the item data for downstream analysis. In various examples, the characteristics of an item may be assigned with weight values based on one or more priority rules. For example, the clothing type is assigned a larger weight value than the level of formalness, which is assigned a larger weight value than the clothing color, based on the one or more priority rules pre-configured by the shipping option management system 204.

The account identifying component 230 is configured to identify a user account associated with a reputation rating above a threshold reputation rating, such as a 4.5 out of 5 ratings, as an example. One or more user accounts may be identified. In various examples, the reputation rating is determined based on an account status being “active” over a pre-determined period of time. A user account may be deactivated by the corresponding user or by the system due to nonuse over an extended period of time. The shipping data may become stale or less relevant in determining the shipping options. By excluding past transaction data associated with the inactive accounts, the shipping option management system may leverage recent shipping data to improve the accuracy and relevancy of the shipping option recommendations.

In various examples, once the user account is identified, the account identifying component 230 is configured to identify a set of transactions associated with the user account. The set of transactions is associated a number of shipped items that share one or more characteristics with the item for listing.

The transaction filtering component 240 is configured to generate a filtered set of transactions based on the location data that includes a delivery location of the item for listing (e.g., the first item). In various examples, the transaction filtering component 240 may be configured to generate a filtered set of transactions based on the item’s shipping and delivery locations.

The shipping option recommendation generating component 250 is configured to identify a shipping option for shipping the item based on the filtered set of transactions. More specifically, the shipping option for shipping the item is identified from shipping options previously selected for shipping items in the filtered set of transactions that share the characteristic with the item. The identified shipping option is associated with a selection probability (e.g., over 50%) higher than the selection probabilities of other shipping options selected by the user account. For example, a flat rate shipping option may be more frequently selected by the seller associated with the user account than an expedited shipping option.

In various examples, the shipping option recommendation generating component 250 is further configured to generate a shipping option recommendation for an item based on the identified shipping option (e.g., first shipping option). In various examples, the shipping option recommendation generating component 250 is further configured to apply other filtering criteria to narrow the set of filtered transactions for downstream analysis. The filtering criteria include, but are not limited to, shipping volume, the price value of the item for listing relative to the shipping costs, complaints history against sellers of the identified user account, etc.

The shipping option recommendation displaying component 260 is configured to cause the display of the shipping option recommendation on a user interface (e.g., as illustrated in FIG. 5 and FIG. 6) of a client device (e.g., client device 110).

The described techniques provide a specific improvement over prior systems, resulting in an improved user interface for electronic devices that display a limited set of information (as illustrated user interface 500 in FIG. 5 and user interface 600 in FIG. 6). For example, the user input display regions 502 and 504, as illustrated in FIG. 5, and user input display region 602, as illustrated in FIG. 6, are greatly simplified to require minimal user input in order to determine shipping options. Additionally, the described techniques provide a particular manner of summarizing and presenting information on electronic devices. For example, the improved user interface collects shipping information (e.g., package weight and dimensions) in a visually intuitive manner. As a further example, the improved user interface presents user interface (UI) icons (instead of generic index or plain texts) to illustrate distinct appearances of shipping boxes (e.g., display region 504) representing various dimensions and weight ranges. The described techniques further provide a particular manner of summarizing and presenting information in electronic devices by organizing buyers’ shipping options (e.g., Buyer’s View) and the associated seller’s responsibilities in separate columns (e.g., display region 506 in FIG. 5). Under this approach, the improved user interface no longer uses conventional user interface methods such as displaying a generic index on a computer.

Under the approach described in various examples herein, the shipping option management system 204 provides functionalities of generating shipping option recommendations based on mining user behavioral data. The user behavioral data includes past transaction history data, such as past transaction history data associated with reputable sellers with larger shipping volumes. The determination is also based on assessing the customer satisfaction rating, the types of shipped items, the price value relative to the shipping costs, whether tracking information is provided, and so on. Under this approach, smaller sellers may benefit from data collected from larger and more sophisticated sellers in the same shipping space, as such sellers who have learned the shipping space and the logistics over time and determined the cost-efficient way to sell the same or similar items. Therefore, their behavioral data serves as a more reliable data source for an accurate determination of cost-effective shipping options.

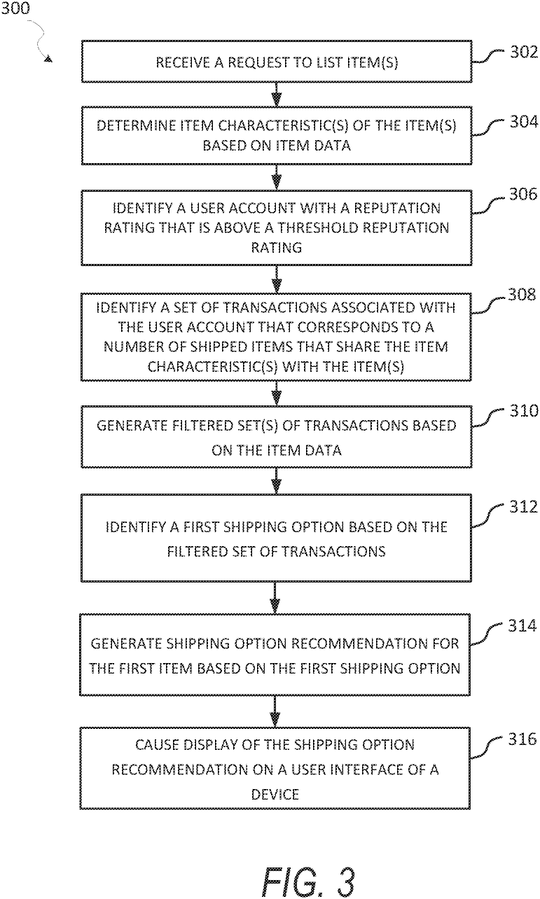

FIG. 3 depicts a flowchart illustrating an example method 300 for generating shipping option recommendations for items by an example shipping option management system during operation, according to various examples. It will be understood that example methods described herein may be performed by a machine in accordance with some examples. For example, method 300 can be performed by the shipping option management system 150 described with respect to FIG. 1 and the shipping option management system 204 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 300 may be represented by executable instructions that, when executed by a processor of a computing device, cause the computing device to perform method 300. Depending on the example, an operation of an example method described herein may be repeated in different ways or involve intervening operations not shown. Though the operations of example methods may be depicted and described in a certain order, the order in which the operations are performed may vary among examples, including performing certain operations in parallel.

At operation 302, the shipping option management system 150 receives a request from a client device 110 to list an item (e.g., the first item) for sale in an online marketplace. The request is associated with item data. Item data may include location data of the item and product information describing one or more characteristics of the item. Characteristics of an item, such as a jacket, may include color, clothing type (e.g., jacket), level of formalness (formal, business casual, casual, sportswear, etc.), style type (trendy, preppy, funky, punk, street, classy, avant-garde, sporty, etc.), and the like. Location data of an item may include the location of the marketplace (e.g., delivery location) and the location of the item (e.g., shipping location).

At operation 304, the shipping option management system 150 determines one or more characteristics of an item based on the item data. In various examples, characteristics of an item may be assigned with weight values based on one or more priority rules. For example, the clothing type is assigned a larger weight value than the level of formalness, which is assigned a larger weight value than the color, based on the one or more priority rules pre-configured by the shipping option management system 204.

At operation 306, the shipping option management system 150 identifies a user account that is associated with a reputation rating above a threshold reputation rating, such as a 4.5 out of 5 ratings, as an example. One or more user accounts may be identified. In various examples, the reputation rating is determined based on an account status being “active” over a pre-determined period of time. As a user account may be deactivated by the corresponding user or by the system due to nonuse over an extended period of time, the shipping data may become stale or less relevant for determining the cost-effective shipping options. By excluding past transaction data associated with the inactive accounts, the shipping option management system may leverage the recent shipping option data to improve the accuracy and relevancy of the shipping option recommendations.

At operation 308, once the user account is identified, the shipping option management system 150 identifies a set of transactions associated with the user account. The set of transactions is associated a number of shipped items that share one or more characteristics with the item for listing.

At operation 310, the shipping option management system 150 generates a filtered set of transactions from the set of transactions based on the location data that includes a delivery location of the item for listing (e.g., the first item). In various examples, the shipping option management system 150 generates a filtered set of transactions based on the item’s shipping and delivery locations. In various examples, the shipping option management system 150 applies other filtering criteria to narrow the set of filtered transactions. The filtering criteria include, but are not limited to, shipping volume, the price value of the item for listing relative to the shipping costs, complaints history against sellers of the identified user account, etc.

At operation 312, the shipping option management system 150 identifies a shipping option for shipping the item based on the filtered set of transactions. More specifically, the shipping option for shipping the item is identified from shipping options previously selected for shipping items in the filtered set of transactions that share the characteristic with the item. The identified shipping option is associated with a selection probability (e.g., over 50%) higher than the selection probabilities of other shipping options selected by the user account. For example, a flat rate shipping option may be more frequently selected by the seller of the user account than an expedited shipping option.

In various examples, the shipping option management system 150 identifies a shipping option for shipping the item based on the filtered set of transactions. More specifically, the shipping option for shipping the item is identified from shipping options previously selected for shipping items in the filtered set of transactions that share the characteristic with the item.

At operation 314, the shipping option management system 150 generates a shipping option recommendation for an item based on the identified shipping option (e.g., first shipping option). In various examples, the shipping option management system 150 applies other filtering criteria to narrow the scope of the identified transactions (and the associated seller accounts) for more targeted downstream analysis. The filtering criteria include but are not limited to the shipping volume of the seller of the user account, the price value of the item for listing relative to the shipping costs, complaints history against sellers of the user account, and the option to provide tracking information.

At operation 316, the shipping option management system 150 causes a display of the shipping option recommendation on a user interface (e.g., as illustrated in FIG. 5 and FIG. 6) of a client device (e.g., client device 110).

Though not illustrated, method 300 can include an operation where a graphical user interface for generating shipping option recommendations for items can be displayed (or caused to be displayed) by the hardware processor. For instance, the operation can cause a client device (e.g., the client device 110 communicatively coupled to the shipping option management system 150) to display the graphical user interface for generating shipping option recommendations for items. This operation for displaying the graphical user interface can be separate from operations 302 through 316 or, alternatively, form part of one or more of operations 302 through 316.

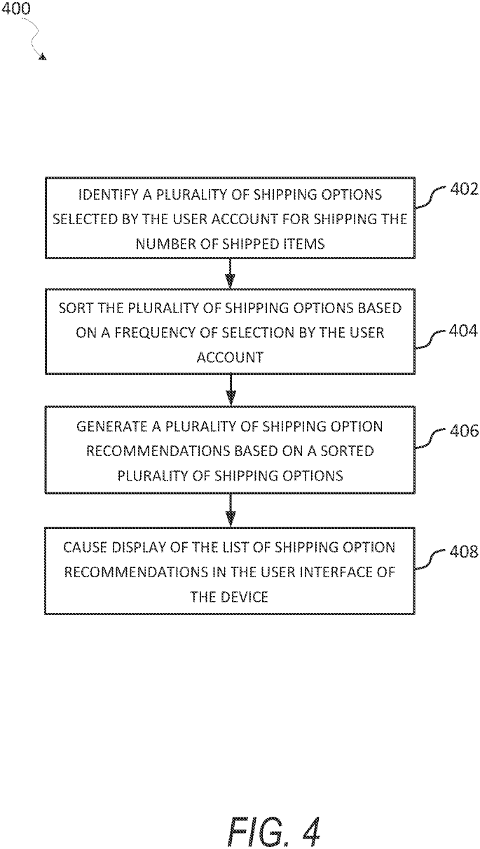

FIG. 4 depicts a flowchart illustrating another example method 400 for generating shipping option recommendations for items by an example shipping option management system during operation, according to various examples. It will be understood that example methods described herein may be performed by a machine in accordance with some examples. For example, method 400 can be performed by the shipping option management system 150 described with respect to FIG. 1 and the shipping option management system 204 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 400 may be represented by executable instructions that, when executed by a processor of a computing device, cause the computing device to perform method 400. Depending on the example, an operation of an example method described herein may be repeated in different ways or involve intervening operations not shown. Though the operations of example methods may be depicted and described in a certain order, the order in which the operations are performed may vary among examples, including performing certain operations in parallel.

At operation 402, the shipping option management system 150 identifies a plurality of shipping options selected by the user account for shipping the number of shipped items that share the characteristic with the item for listing. The plurality of shipping options includes the first shipping option identified to be associated with the selection probability higher than the selection probabilities of other shipping options selected by the user account.

At operation 404, the shipping option management system 150 sorts the plurality of shipping options based on the frequency of selection by the user account in descending order, as an example.

In various examples, the shipping option management system 150 may sort the plurality of shipping options based on user preferences learned by the system 150 over a period of time. For example, seller X (e.g., a seller that lists items for sale) prefers a carrier Y based on location proximity to a drop of center. User preference may be determined based on user selections of shipping options or based on user input. The shipping option management system 150 may prioritize the shipping options associated with carrier Y over other carriers when sorting the plurality of shipping options.

At operation 406, the shipping option management system 150 generates a plurality of shipping option recommendations based on a sorted plurality of shipping options. Each shipping option may include one or more of: a name of the shipping option (e.g., standard shipping, economy shipping, or expedited shipping, etc.), delivery time (e.g., 3-5 days), the responsible party for bearing the shipping costs, and the costs of shipping.

At operation 408, the shipping option management system 150 causes a display of the plurality of shipping option recommendations in the user interface of the client device 110. For example, an example plurality of shipping option recommendations is illustrated in display region 604 in FIG. 6. The shipping options are sorted in descending order based on the frequency of selection by the one or more identified user accounts. As illustrated in FIG. 6, the standard shipping option is more frequently selected by the one or more identified user accounts than the economy and expedited shipping options for shipping a women’s top from the item location (e.g., Japan).

In various examples, the shipping option management system 150 detects an indication of user selection of an interactive element (e.g., element 510) to remove a shipping option recommendation (e.g., economy shipping illustrated in the display region 508) from a user interface (e.g., user interface 500) of a client device. In response to detecting the user selection, the shipping option management system 150 may cause the shipping option recommendation to be removed from the user interface of the client device.

In various examples, the shipping option management system 150 receives a request (e.g., the second request) from a client device (or an identified user account) that requested to list a previously listed item (e.g., the first item). The item requested to be listed shares the same or similar item data and location data as the previously listed item. The shipping option management system 150 detects that the first shipping option recommendation for shipping the first item was previously requested to be removed via the user interface of the device. The shipping option management system 150 determines that a shipping option recommendation (e.g., second shipping option recommendation) generated for shipping the second item matches the first shipping option recommendation for shipping the previously listed item. In various examples, the shipping option management system 150 causes the display of the second shipping option recommendation in the user interface of the client device in a display format visually distinguishable from other displayed shipping option recommendations. A visually distinguishable display format may be a display format with lightened color (e.g., texts in grey and/or translucent color, as opposed to solid black color), or a display format with a different type of font or content layout, etc.

Though not illustrated, method 400 can include an operation where a graphical user interface for generating shipping option recommendations for items can be displayed (or caused to be displayed) by the hardware processor. For instance, the operation can cause a client device (e.g., the client device 110 communicatively coupled to the shipping option management system 150) to display the graphical user interface for generating shipping option recommendations for items. This operation for displaying the graphical user interface can be separate from operations 402 through 408 or, alternatively, form part of one or more of operations 402 through 408.

FIG. 5 depicts a block diagram illustrating an example user interface 500 caused to be displayed by an example shipping option management system during operation, according to various examples. As shown, the user interface 500 includes display regions 502 and 504 for collecting user input with respect to shipping information of the item for listing. Under various examples as disclosed herein, the user is only required to select the marketplace, product category, location, quantity, and the size of the packaging of the item before the shipping option management system 150 generates one or more shipping option recommendations (as illustrated in display region 506), based on operations of method 300 and method 400 shown in FIG. 3 and FIG. 4, or as elsewhere described herein.

As illustrated in FIG. 5, the user interface 500 includes a first region (e.g., display region 508) that displays a type of shipping service (e.g., economy shipping) and an interactive element (e.g., element 510) to remove the shipping option recommendation from the user interface 500. The user interface 500 includes a second region (e.g., display region 512) that displays a shipping carrier (e.g., ABC Mail) and a third region (e.g., display region 512) that displays an estimated cost 514 (e.g., $2.29) associated with the shipping option recommendation.

FIG. 6 depicts a block diagram illustrating an example user interface 600 caused to be displayed by an example shipping option management system during operation, according to various examples. FIG. 6 illustrates an example user interface 600 displaying a plurality of shipping option recommendations for international shipping, as the item location is in “Japan,” whereas the marketplace is the “US,” as illustrated in display region 602. The shipping option management system 150 is able to perform operations of method 300 and method 400 shown in FIG. 3 and FIG. 4, or as elsewhere described herein, to leverage international shipping data.

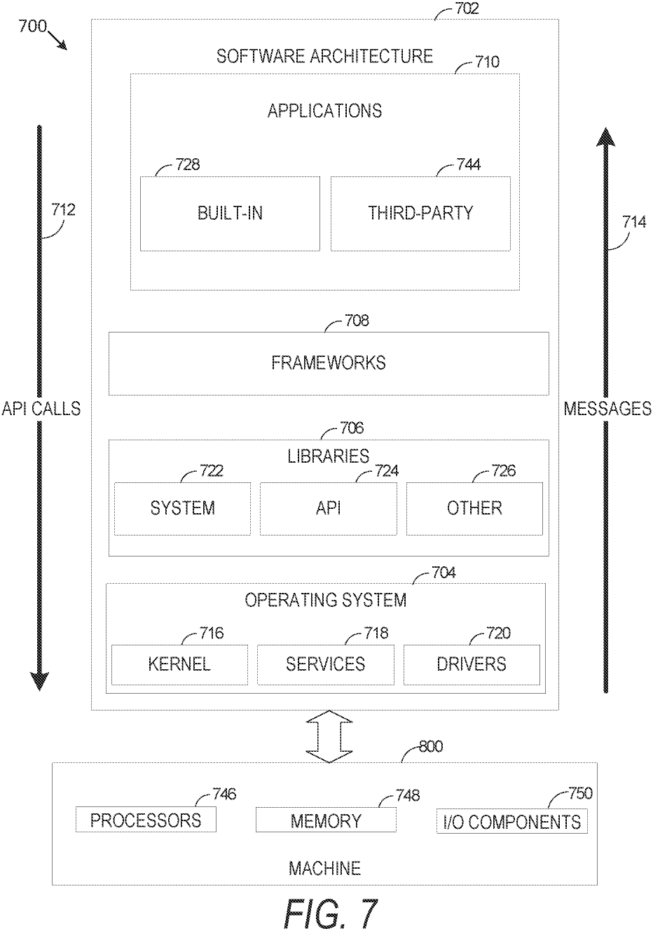

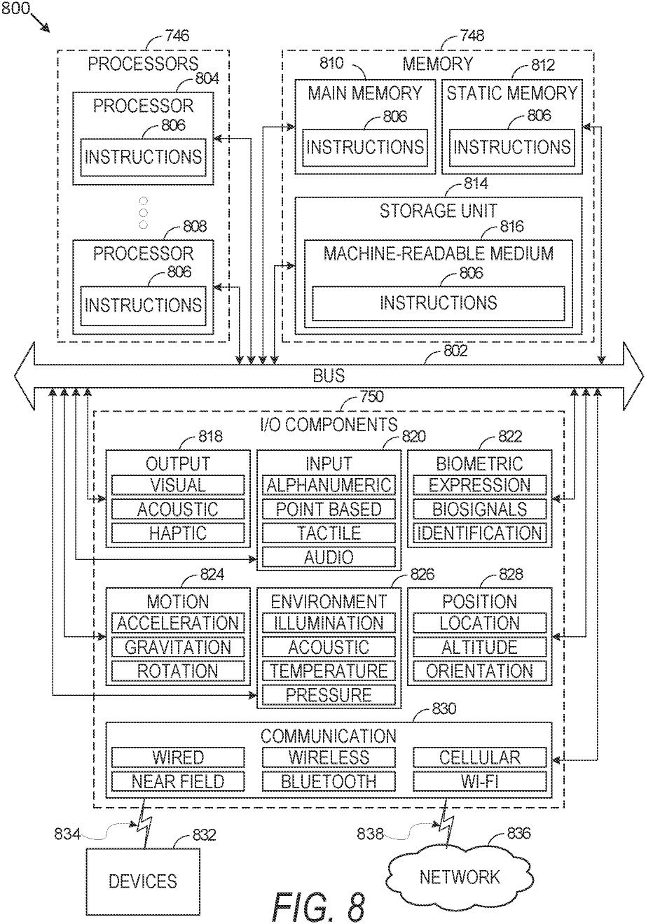

FIG. 7 depicts a block diagram 700 illustrating an architecture of software 702, which can be installed on any one or more of the devices described above. FIG. 7 is merely a non-limiting example of a software architecture, and it will be appreciated that many other architectures can be implemented to facilitate the functionality described herein. In various examples, the software 702 is implemented by hardware such as a machine 800 of FIG. 8 that includes processor(s) 746, memory 748, and I/O components 750. In this example architecture, the software 702 can be conceptualized as a stack of layers where each layer may provide a particular functionality. For example, the software 702 includes layers such as an operating system 704, libraries 706, frameworks 708, and applications 710. Operationally, the applications 710 invoke API calls 712 (application programming interface) through the software stack and receive messages 714 in response to the API calls 712, consistent with some examples.

In various implementations, the operating system 704 manages hardware resources and provides common services. The operating system 704 includes, for example, a kernel 716, services 718, and drivers 720. The kernel 716 acts as an abstraction layer between the hardware and the other software layers, consistent with some examples. For example, the kernel 716 provides memory management, processor management (e.g., scheduling), component management, networking, and security settings, among other functionalities. The services 718 can provide other common services for the other software layers. The drivers 720 are responsible for controlling or interfacing with the underlying hardware, according to some examples. For instance, the drivers 720 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some examples, the libraries 706 provide a low-level common infrastructure utilized by the applications 710. The libraries 706 can include system libraries 122 (e.g., C standard library) that can provide functions such as memory allocation functions, string manipulation functions, mathematic functions, and the like. In addition, the libraries 706 can include API libraries 724 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 706 can also include a wide variety of other libraries 71.6 to provide many other APIs to the applications 710.

The frameworks 708 provide a high-level common infrastructure that can be utilized by the applications 710, according to some examples. For example, the frameworks 708 provide various graphical user interface (GUI) functions, high-level resource management, high-level location services, and so forth. The frameworks 708 can provide a broad spectrum of other APIs that can be utilized by the applications 710, some of which may be specific to a particular operating system or platform.

In an example, the applications 710 include built-in applications 728 and a broad assortment of other applications, such as a third-party application 744. The built-in applications 728 may include a home application, a contacts application, a browser application, a book reader application, a location application, a media application, a messaging application, a game application. According to some examples, the applications 710 are programs that execute functions defined in the programs. Various programming languages can be employed to create one or more of the applications 710, structured in a variety of manners, such as object-oriented programming languages (e.g., Objective-C, Java, or C++) or procedural programming languages (e.g., C or assembly language). In a specific example, the third-party application 744 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 744 can invoke the API calls 712 provided by the operating system 704 to facilitate functionality described herein.

FIG. 8 illustrates a diagrammatic representation of a machine 800 in the form of a computer system within which a set of instructions may be executed for causing the machine to perform any one or more of the methodologies discussed herein, according to some examples. Specifically, FIG. 8 shows a diagrammatic representation of the machine 800 in the example form of a computer system, within which instructions 806 (e.g., software, a program, an application, an applet, an app, or other executable code) for causing the machine 800 to perform any one or more of the methodologies discussed herein may be executed. Additionally, or alternatively, the instructions 806 may implement the operations of method 300 and method 400 shown in FIG. 3 and FIG. 4, or as elsewhere described herein.

The instructions 806 transform the general, non-programmed machine 800 into a particular machine 800 programmed to carry out the described and illustrated functions in the manner described. In alternative examples, the machine 800 operates as a stand-alone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 806, sequentially or otherwise, that specify actions to be taken by the machine 800. Further, while only a single machine 800 is illustrated, the term “machine” shall also be taken to include a collection of machines 800 that individually or jointly execute the instructions 806 to perform any one or more of the methodologies discussed herein.

The machine 800 may include processor(s) 746, memory 748, and I/O components 750, which may be configured to communicate with each other such as via a bus 802. In some examples, the processor(s) 746 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 804 and a processor 808 that may execute the instructions 806. The term “processor” is intended to include multi-core processors that may comprise two or more independent processors (sometimes referred to as “cores”) that may execute instructions contemporaneously. Although FIG. 8 shows multiple processor(s) 746, the machine 800 may include a single processor with a single core, a single processor with multiple cores (e.g., a multi-core processor), multiple processors with a single core, multiple processors with multiples cores, or any combination thereof.

The memory 748 may include a main memory 810, a static memory 812, and a storage unit 814, each accessible to the processor(s) 746 such as via the bus 802. The main memory 810, the static memory 812, and storage unit 814 store the instructions 806 embodying any one or more of the methodologies or functions described herein. The instructions 806 may also reside, completely or partially, within the main memory 810, within the static memory 812, within the storage unit 814, within at least one of the processor(s) 746 (e.g., within the processor’s cache memory), or any suitable combination thereof, during execution thereof by the machine 800.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 8. The I/O components 750 are grouped according to functionality merely for simplifying the following discussion and the grouping is in no way limiting. In some examples, the I/O components 750 may include output components 818 and input components 820. The output components 818 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 820 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In some examples, the I/O components 750 may include biometric components 822, motion components 824, environmental components 826, or position components 828, among a wide array of other components. For example, the biometric components 822 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 824 may include acceleration sensor components (e.g., accelerometer), gravitation sensor components, rotation sensor components (e.g., gyroscope), and so forth. The environmental components 826 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 828 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 830 operable to couple the machine 800 to a network 836 or devices 832 via a coupling 838 and a coupling 834, respectively. For example, the communication components 830 may include a network interface component or another suitable device to interface with the network 836. In further examples, the communication components 830 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 832 may be another machine or any of a wide variety of peripheral devices (e.g., a peripheral device coupled via a USB).

Moreover, the communication components 830 may detect identifiers or include components operable to detect identifiers. For example, the communication components 830 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 830, such as location via Internet Protocol (IP) geolocation, location via Wi-Fi® signal triangulation, location via detecting an NFC beacon signal that may indicate a particular location, and so forth.

The various memories (i.e., memory 748, main memory 810, and/or static memory 812) and/or storage unit 814 may store one or more sets of instructions and data structures (e.g., software) embodying or utilized by any one or more of the methodologies or functions described herein. These instructions (e.g., the instructions 806), when executed by processor(s) 746, cause various operations to implement the disclosed examples.

Certain examples are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various examples, one or more computer systems (e.g., a stand-alone computer system, a client computer system, or a server computer system) or one or more hardware modules of a computer system (e.g., a processor or a group of processors) are configured by software (e.g., an application or application portion) as a hardware module that operates to perform certain operations as described herein.

In various examples, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In examples in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers, with these operations being accessible via a network (e.g., the Internet) and via one or more appropriate interfaces (e.g., an API). In certain examples, for example, a client device may relay or operate in communication with cloud computing systems and may access circuit design information in a cloud environment.

The performance of certain of the operations may be distributed among the processors, not only residing within a single machine, but deployed across a number of machines. In some examples, the processors or processor-implemented modules are located in a single geographic location (e.g., within a home environment, an office environment, or a server farm). In other examples, the processors or processor-implemented modules are distributed across a number of geographic locations.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In some examples, one or more portions of the network 836 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 836 or a portion of the network 836 may include a wireless or cellular network, and the coupling 838 may be a Code Division Multiple Access (CDMA) connection, a Global System for Mobile communications (GSM) connection, or another type of cellular or wireless coupling. In this example, the coupling 838 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 806 may be transmitted or received over the network 836 using a transmission medium via a network interface device (e.g., a network interface component included in the communication components 830) and utilizing any one of a number of well-known transfer protocols (e.g., hypertext transfer protocol (HTTP)). Similarly, the instructions 806 may be transmitted or received using a transmission medium via the coupling 834 (e.g., a peer-to-peer coupling) to the devices 832. The terms “non-transitory computer-readable storage medium,” “transmission medium” and “signal medium” mean the same thing and may be used interchangeably in this disclosure. The terms “transmission medium” and “signal medium” shall be taken to include any intangible medium that is capable of storing, encoding, or carrying the instructions 806 for execution by the machine 800, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

The terms “machine-readable medium,” “non-transitory computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

Although examples have been described with reference to some examples or methods, it will be evident that various modifications and changes may be made to these examples without departing from the broader scope of the examples. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This detailed description, therefore, is not to be taken in a limiting sense, and the scope of various examples is defined only by the appended claims, along with the full range of equivalents to which such claims are entitled.

Such examples of the inventive subject matter may be referred to herein, individually and/or collectively, by the term “invention” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

### Glossary

“CARRIER SIGNAL” in this context refers to any intangible medium that is capable of storing, encoding, or carrying instructions for execution by the machine 800, and includes digital or analog communications signals or other intangible medium to facilitate communication of such instructions 806. Instructions 806 may be transmitted or received over the network 836 using a transmission medium via a network interface device and using any one of a number of well-known transfer protocols.

“CLIENT DEVICE” in this context refers to any machine 800 that interfaces to a communications network 836 to obtain resources from one or more server systems or other client devices 110. A client device 110 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 836.

“COMMUNICATIONS NETWORK” in this context refers to one or more portions of a network 836 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 836 or a portion of a network 836 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device, or other tangible media able to store instructions 806 and data temporarily or permanently and may include, but is not limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 806. The term “machine-readable medium” shall also be taken to include any medium, or combination of multiple media, that is capable of storing instructions 806 (e.g., code) for execution by a machine 800, such that the instructions 806, when executed by one or more processors 804 of the machine 800, cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a stand-alone computer system, a client computer system, or a server computer system) or one or more hardware components of a computer system (e.g., a processor or a group of processors 746) may be configured by software (e.g., an application 710 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor 804 or other programmable processors. Once configured by such software, hardware components become specific machines 800 (or specific components of a machine 800) uniquely tailored to perform the configured functions and are no longer general-purpose processors 804. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor 804 configured by software to become a special-purpose processor, the general-purpose processor 804 may be configured as respectively different special-purpose processors (e.g., comprising different hardware components) at different times. Software accordingly configures a particular processor or processors 746, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 802) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 746 that are temporarily configured (e.g., by software) or permanently configured to perform the relevant operations. Whether temporarily or permanently configured, such processors 746 may constitute processor-implemented components that operate to perform one or more operations or functions described herein. As used herein, “processor-implemented component” refers to a hardware component implemented using one or more processors 746. Similarly, the methods described herein may be at least partially processor-implemented, with a particular processor or processors 746 being an example of hardware. For example, at least some of the operations of a method may be performed by one or more processors 746 or processor-implemented components. Moreover, the one or more processors 746 may also operate to support performance of the relevant operations in a “cloud computing” environment or as a “software as a service” (SaaS). For example, at least some of the operations may be performed by a group of computers (as examples of machines 800 including processors 746), with these operations being accessible via a network 836 (e.g., the Internet) and via one or more appropriate interfaces (e.g., an API). The performance of certain of the operations may be distributed among the processors 746, not only residing within a single machine 800, but deployed across a number of machines 800. In some examples, the processors 746 or processor-implemented components may be located in a single geographic location (e.g., within a home environment, an office environment, or a server farm). In other examples, the processors 746 or processor-implemented components may be distributed across a number of geographic locations.

“PROCESSOR” in this context refers to any circuit or virtual circuit (a physical circuit emulated by logic executing on an actual processor 804) that manipulates data values according to control signals (e.g., “commands,” “op codes,” “machine code,” etc.) and which produces corresponding output signals that are applied to operate a machine 800. A processor 804 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor 804 may further be a multi-core processor having two or more independent processors 746 (sometimes referred to as “cores”) that may execute instructions 806 contemporaneously.

What is claimed is:

1. A method comprising:
receiving a request to list a first item for sale in an online marketplace, the request being associated with item data that includes location data of the first item;
determining a characteristic of the first item based on the item data;
identifying a user account with a reputation rating that is above a threshold reputation rating;
identifying, by one or more hardware processors, a set of transactions associated with the user account that correspond to a number of shipped items that share the characteristic with the first item;
generating a filtered set of transactions from the set of transactions based on the location data that includes a delivery location of the first item;
identifying, based on the filtered set of transactions, a first shipping option with a selection probability higher than selection probabilities of other shipping options selected by the user account;
generating a shipping option recommendation for the first item based on the first shipping option; and
causing display of the shipping option recommendation on a user interface of a device.

2. The method of claim 1, wherein the user interface comprises a first region displaying a type of shipping service and an interactive element to remove the shipping option recommendation from the user interface, a second region displaying a shipping carrier associated with the shipping option recommendation, and a third region displaying an estimated cost associated with the shipping option recommendation.

3. The method of claim 2, further comprising:
detecting an indication of a user interaction with the interactive element; and
causing the shipping option recommendation to be removed from the user interface of the device based on the indication.

4. The method of claim 1, wherein the shipping option recommendation is a first shipping option recommendation, wherein the request is a first request, and wherein the method further comprises:
receiving a second request to list a second item, the second request being associated with the item data and the location data of the first item;
detecting that the first shipping option recommendation for shipping the first item is previously requested to be removed via the user interface of the device;
determining that a second shipping option recommendation for shipping the second item matches the first shipping option recommendation for shipping the first item; and
causing display of the second shipping option recommendation in the user interface of the device in a display format that is visually distinguishable from other displayed shipping option recommendations.

5. The method of claim 1, further comprising:
identifying a plurality of shipping options selected by the user account for shipping the number of shipped items, the plurality of shipping options including the first shipping option;
sorting the plurality of shipping options based on a frequency of selection by the user account;
generating a plurality of shipping option recommendations based on a sorted plurality of shipping options; and
causing display of the plurality of shipping option recommendations in the user interface of the device.

6. The method of claim 1, wherein the item data comprises one or more of: a product category of the first item, a quantity of the first item, and a size of a package that fits the first item.

7. The method of claim 1, wherein the location data comprises one or more of: a current location of the first item and a delivery location of the first item.

8. The method of claim 1, further comprising:
updating the filtered set of transactions by excluding a transaction based on an occurrence of an event associated with the transaction.

9. The method of claim 8, wherein the event includes one of: a late delivery and a negative review from a buyer of the transaction.

10. The method of claim 1, wherein the user account is associated with an active account status for a time period above a threshold time period.

11. A system comprising:
a memory storing instructions; and
one or more hardware processors communicatively coupled to the memory and configured by the instructions to perform operations comprising:
receiving a request to list a first item for sale in an online marketplace, the request being associated with item data that includes location data of the first item;
determining a characteristic of the first item based on the item data;
identifying a user account with a reputation rating that is above a threshold reputation rating;
identifying a set of transactions associated with the user account that correspond to a number of shipped items that share the characteristic with the first item;
generating a filtered set of transactions from the set of transactions based on the location data that includes a delivery location of the first item;
identifying, based on the filtered set of transactions, a first shipping option with a selection probability higher than selection probabilities of other shipping options selected by the user account;
generating a shipping option recommendation for the first item based on the first shipping option; and
causing display of the shipping option recommendation on a user interface of a device.

12. The system of claim 11, wherein the user interface comprises a first region displaying a type of shipping service and an interactive element to remove the shipping option recommendation from the user interface, a second region displaying a shipping carrier associated with the shipping option recommendation, and a third region displaying an estimated cost associated with the shipping option recommendation.

13. The system of claim 12, wherein the operations further comprise:
detecting an indication of a user interaction with the interactive element; and
causing the shipping option recommendation to be removed from the user interface of the device based on the indication.

14. The system of claim 11, wherein the shipping option recommendation is a first shipping option recommendation, wherein the request is a first request, and wherein the operations further comprise:
receiving a second request to list a second item, the second request being associated with the item data and the location data of the first item;
detecting that the first shipping option recommendation for shipping the first item is previously requested to be removed via the user interface of the device;
determining that a second shipping option recommendation for shipping the second item matches the first shipping option recommendation for shipping the first item; and
causing display of the second shipping option recommendation in the user interface of the device in a display format that is visually distinguishable from other displayed shipping option recommendations.

15. The system of claim 11, wherein the operations further comprise:
identifying a plurality of shipping options selected by the user account for shipping the number of shipped items, the plurality of shipping options including the first shipping option;
sorting the plurality of shipping options based on a frequency of selection by the user account;
generating a plurality of shipping option recommendations based on a sorted plurality of shipping options; and
causing display of the plurality of shipping option recommendations in the user interface of the device.

16. The system of claim 11, wherein the item data comprises one or more of: a product category of the first item, a quantity of the first item, and a size of a package that fits the first item.

17. The system of claim 11, wherein the location data comprises one or more of: a current location of the first item and a delivery location of the first item.

18. The system of claim 11, wherein the operations further comprise:
updating the filtered set of transactions by excluding a transaction based on an occurrence of an event associated with the transaction.

19. The system of claim 18, wherein the event includes one of: a late delivery and a negative review from a buyer of the transaction.

20. A non-transitory computer-readable storage medium comprising instructions that, when executed by a processing device, cause the processing device to perform operations comprising:
receiving a request to list a first item for sale in an online marketplace, the request being associated with item data that includes location data of the first item;
determining a characteristic of the first item based on the item data;
identifying a user account with a reputation rating that is above a threshold reputation rating;
identifying a set of transactions associated with the user account that correspond to a number of shipped items that share the characteristic with the first item;
generating a filtered set of transactions from the set of transactions based on the location data that includes a delivery location of the first item;
identifying, based on the filtered set of transactions, a first shipping option with a selection probability higher than selection probabilities of other shipping options selected by the user account;
generating a shipping option recommendation for the first item based on the first shipping option; and
causing display of the shipping option recommendation on a user interface of a device.
